(19) United States
(12) Patent Application Publication
(10) Pub. No.: US 2026/0212120 A1
(43) Pub. Date: Jul. 23, 2026

(54) MOTIF DETECTION

(71) Applicant: NEC Laboratories America, Inc., Princeton, NJ (US)

(72) Inventors: Wei Cheng, Princeton Junction, NJ (US); Haifeng Chen, West Windsor, NJ (US)

(21) Appl. No.: 19/453,571

(22) Filed: Jan. 20, 2026

Related U.S. Application Data
(60) Provisional application No. 63/747,599, filed on Jan. 21, 2025.

(51) Int. Cl. G06F 40/284; G06F 16/353

(52) U.S. Cl. CPC G06F 40/284; G06F 16/353

(57) ABSTRACT

Systems and methods for detecting machine-generated texts by detecting motifs. The system and method including tokenizing documents into token sequences, generating at least one graph where tokens and documents are nodes, wherein the tokens are one-hot features and the documents are zero features, and wherein the graph has at least two types of connections, at least one type connects documents to tokens that the documents contain, and at least one other type links tokens that frequently appear together across all documents, classifying each node in the at least one graph using a graph neural network (GNN), and generating an optimal explanation subgraph from the classified graph, wherein the optimal explanation subgraph represents a motif. The optimal explanation subgraph can later be used to support artificial intelligence (AI) agent decision-making.

### RELATED APPLICATION INFORMATION

This application claims priority to U.S. Provisional Patent Application No. 63/747,599, filed on Jan. 21, 2025, incorporated herein by reference in its entirety.

### BACKGROUND

### Technical Field

The present invention relates to detecting machine-generated texts and more particularly detecting machine-generated texts by detecting motifs.

### Description of the Related Art

Large language models (LLMs) have demonstrated remarkable capabilities in generating natural text across diverse tasks, raising significant concerns about authorship authentication. While numerous detectors have emerged to distinguish between machine-generated texts (MGTs) and human-generated texts (HGTs), the explainability of these detection methods remains unexplored. This problem is magnified by the fact LLMs often function as black-box systems, presenting inherent risks for downstream applications. Traditional explainable approaches, fail to adequately capture the intricate word dependencies that differentiate HGTs from MGTs. Thus, there is a need for detection methods that provide explanations.

### SUMMARY

According to an aspect of the present invention, a method is provided for detecting machine-generated text, the method including tokenizing documents into token sequences, generating at least one graph where tokens and documents are nodes, wherein the tokens are one-hot features and the documents are zero features, and wherein the graph has at least two types of connections, at least one type connects documents to tokens that the documents contain, and at least one other type links tokens that frequently appear together across all documents, classifying each node in the at least one graph using a graph neural network (GNN), and generating an optimal explanation subgraph from the classified graph, wherein the explanation subgraph represents a motif.

According to another aspect of the present invention, a system is provided for detecting machine-generated text, the system including a memory device, one or more processor devices operatively coupled with the memory device to perform operations, the operations including tokenize documents into token sequences, generate at least one graph where tokens and documents are nodes, wherein the tokens are one-hot features and the documents are zero features, and wherein the graph has at least two types of connections, at least one type connects documents to tokens that the documents contain, and at least one other type links tokens that frequently appear together across all documents, classify each node in the at least one graph using a graph neural network (GNN), and generate an optimal explanation subgraph from the classified graph, wherein the explanation subgraph represents a motif.

According to another aspect of the prevent invention, a non-transitory computer program product is provided for detecting machine-generated text, the non-transitory computer program product including a computer-readable storage medium including a program code, wherein the program code when executed on a computer causes the computer to perform tokenize documents into token sequences, generate at least one graph where tokens and documents are nodes, wherein the tokens are one-hot features and the documents are zero features, and wherein the graph has at least two types of connections, at least one type connects documents to tokens that the documents contain, and at least one other type links tokens that frequently appear together across all documents, classify each node in the at least one graph using a graph neural network (GNN), and generate an optimal explanation subgraph from the classified graph, wherein the explanation subgraph represents a motif, wherein generate an optimal explanation subgraph further includes balance the size of the optimal explanation with the relevancy of the optimal explanation.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for motif detection, in accordance with an embodiment of the present invention;

FIG. 2 is a diagram illustrating a practical application for motif detection in healthcare, in accordance with an embodiment of the present invention;

FIG. 3 is a diagram illustrating a graph for obtaining motifs, in accordance with an embodiment of the present invention;

FIG. 4 is a flow diagram illustrating an obtained motif, in accordance with an embodiment of the present invention;

FIG. 5 is a block diagram of a computer system for motif detection, in accordance with an embodiment of the present invention; and

FIG. 6 is a flow diagram of a high-level overview of motif detection, in accordance with an embodiment of the present invention.

### DETAILED DESCRIPTION OF PREFERRED EMBODIMENTS

In accordance with embodiments of the present invention, systems and methods are provided to/for obtaining motifs.

Embodiments of the present invention relate to identifying machine-generated texts versus human-generated texts. Embodiments accomplish this by tokenizing the documents and generating a graph based off the tokens and documents. This allows the identification of patterns (motifs) in the graph structure that are attributable to machine-generated texts. Then, the graph is classified using a graph neural network. This determines whether the text was machine-generated or human-generated. Then, motifs are obtained by obtaining an optimal explanation subgraph, with the optimal explanation subgraph being representative of the motif. The optimal explanation subgraph provides the explanation for the determination that the text is either human-generated or machine-generated. Embodiments can generate the optimal explanation subgraph by balancing the size of the optimal explanation subgraph with the relevancy of the optimal explanation subgraph.

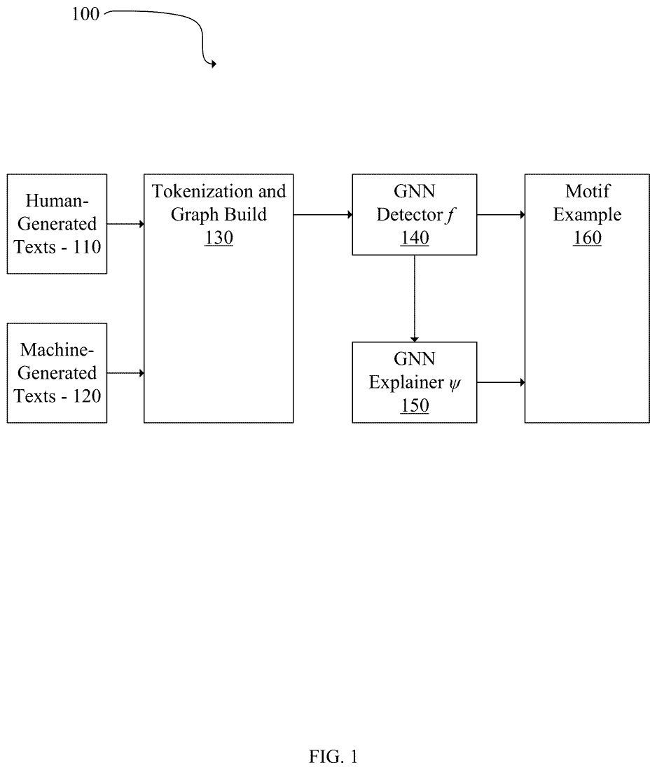

Referring now in detail to the figures in which like numerals represent the same or similar elements and initially to FIG. 1, a high-level system/method 100 for detecting machine-generated text is illustratively depicted in accordance with one embodiment of the present invention. In block 110 and block 120, human-generated texts and machine-generated texts are sent to block 130. In block 130, the texts are tokenized using a tokenizer and a graph is built mapping out the tokens and the documents containing the texts. In block 140, the graph neural network (GNN) classifies the graph using GNN detector f. By using a graph, the system/method 100 represents an improvement by increasing reliability while better utilizing a training data set. The GNN detector f can determine whether the text is human-generated or machine generated using a graph convolutional network (GCN). The GNN detector f can be pre-trained. In block 150, the classified graph is interpreted by the GNN explainer ψ. Then in block 160, a motif via optimal explanation subgraph is provided by the GNN explainer ψ.

A practical application of the embodiments is that one can discover what patterns distinguish between human-generated text and machine-generated text. For example, the motif obtained by the GNN explainer ψ can be a word scheme or sentence structure that distinguishes machine-generated texts from human-generated texts.

Another practical application of the embodiments is that one can use the discovered patterns to support decision making regarding the authorship of the text data.

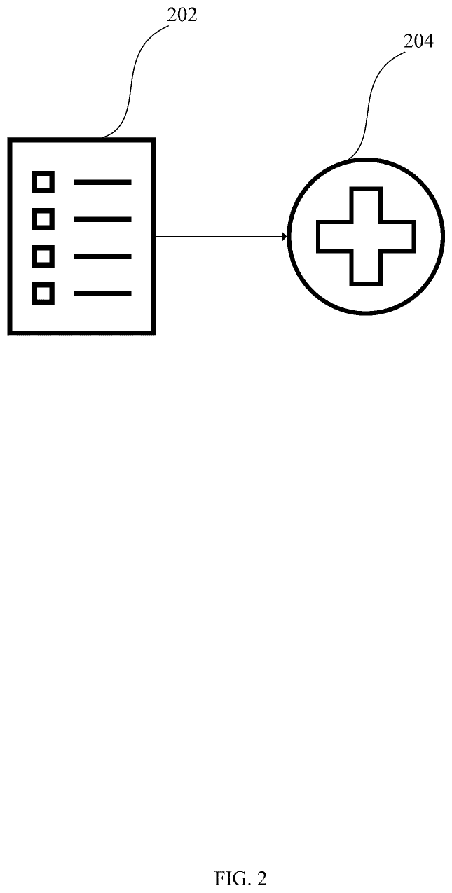

Another practical application of the embodiments is to determine if the healthcare information provided is fraudulent. Referring to FIG. 2, healthcare information 202 is provided to a healthcare provider 204. The healthcare provider 204 uses embodiments of the invention to determine whether the healthcare information 202 is generated using artificial intelligence. Embodiments of the present invention can then determine whether the healthcare information 202 is human-generated or machine-generated and further provide an explanation for the determination. If the healthcare information 202 is determined to be machine-generated, then fraud has been uncovered.

Embodiments relate to an improvement because the present invention results in better reliability while exhibiting higher data utilization efficiency. Furthermore, embodiments relate to an improvement by being able to provide explanations for how a model determines whether the text is human-generated or machine-generated.

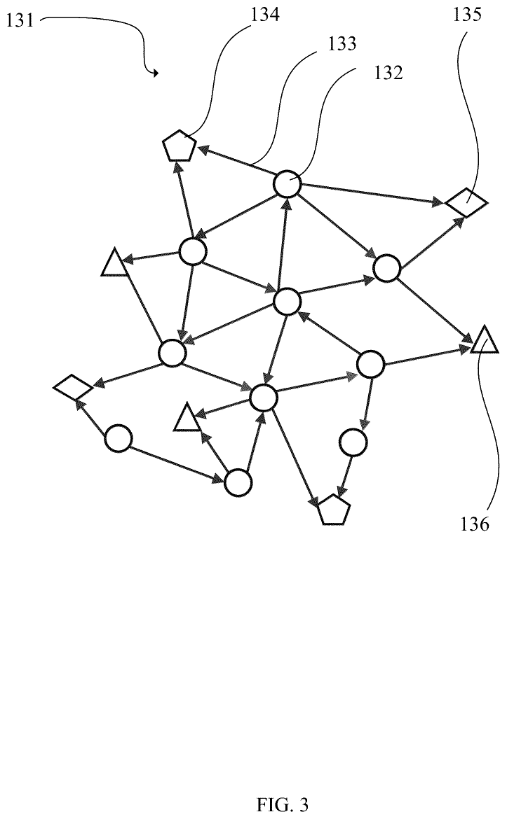

Referring now to FIG. 3, a graph 131 built by the system and method is illustratively depicted in accordance with an embodiment of the present invention. An advantage of using graph structures is that the graph structures directly show how tokens relate to each other based on training data patterns. Furthermore, by using a graph, embodiments of the invention represent an improvement by being able to determine an explanation for why a text was determined to be human-generated vs machine-generated. In this graph 131, nodes 132 can be either documents or tokens. The tokens can have one-hot features while the documents can have all zero features. Continuing with describing graph 131, the pentagon 134 represents unknown text, the diamond 135 represents machine generated texts, and the triangle 136 represents human generated texts. There can be two types of connections 133 in the graph 131. One type of connection can connect documents to the tokens that the documents contain. The other type of connection can link tokens that frequently appear together across all documents. Similar to feature selection, what is considered frequent can be determined by sparse learning with one parameter to control for sparsity. The edge attribution between documents and tokens can be the term frequency-inverse document frequency (TF-IDF) of the word in the document. This can capture how important a word is to a document. The graph 131 can use point-wise mutual information (PMI) to represent the edge attribution along tokens, which utilize a fixed-length sliding window on documents. This results in only positive PMI edges being kept, meaning only statistically meaningful dependencies form edges. Formally, the edge attributions matrix can be defined as:

$${I}_{ij} = \{ \begin{matrix}PMI ( i , j ) & i , j are token , PMI ( i , j ) > 0 \\ TF - {IDF}_{ij} & i is document , j is token \\ 1 & i = j \\ 0 & otherwise\end{matrix} \qquad EQ . 4$$

where

$$PMI ( i , j ) = log \frac{p ( i , j )}{p ( i ) p ( j )} ,$$

p(i) is the frequency of i-th token in all windows, and p(i, j) is the co-occurrence frequency of i-th and j-th tokens.

Referring back to FIG. 1, after obtaining the document and token graph, in block 140, the GNN detector f can be a three-layer GCN to make classifications. The input dimension of a first layer of the GCN can be dependent on the token size of a training set. A second layer of the GCN can have a hidden dimension of 64, and an output layer of the GCN has a dimensionality that is fixed to the number of text categories. The GNN detector f can be pre-trained. The process of making classification can distinguish machine-generated texts from human-generated texts. Formally, the update of one layer the following:

$${H}^{( l + 1 )} = σ ( {\tilde{D}}^{- \frac{1}{2}} \tilde{A} {\tilde{D}}^{- \frac{1}{2}} {H}^{( l )} {W}^{( l )} ) , \qquad EQ . 5$$

where Ã=A+E, Eis the identity matrix, \tilde{D}ᵢᵢ=Σⱼ Ãᵢⱼ is a degree matrix. Edge attribution defined as Ã=A⊙I+E, where ⊙ is the Hadamard product. The loss function is defined as the aggregate cross-entropy error over the set of labeled documents:

$$ℒ = - {\sum }_{d ∈ {y}_{D}} {\sum }_{f = 1}^{F} {Y}_{df} {ln Z}_{df} , \qquad EQ . 6$$

where [symbol] is the indice of document nodes in training set. Z=softmax (H) is the final output of GCN, where H is the final node embeddings.

Continuing with reference to FIG. 1, rather than extract the token's dependency with other tokens, in block 150, the GNN explainer y can obtain optimal explanation subgraphs from the dependency graphs to explain how the GNN detector fin block 140 made a determination that a text is machine-generated or human generated. The GNN explainer y can use a GCN. The optimal explanation subgraph can be smaller patterns (motifs) within the dependency graphs. The motifs can range from word choice to sentence structure. The explainable tasks in graphs can be defined as follows:

For a node classification task, an explanation function is a mapping

Ψ=G→Gₛ. For a given pair of parameters, (i)I(Y; G̅| [symbol] _{Ψ(G)})≤κ, (ii) [symbol] (|Gₛ|)≤s, where G̅ is graph with unlabeled nodes and

$$I ( Y ; \overline{G} \vert {\text{?}}_{Ψ ( G )} ) {=}^{△} {\sum }_{{g}_{s}} {P}_{Ψ ( G )} ( {g}_{s} ) {\sum }_{y , \overline{g}} {P}_{Y , \overline{G}} ( y , \overline{g} \vert {g}_{s} ⊆ \overline{G} ) \times log \frac{{P}_{Y , \overline{G}} ( y , \overline{g} \vert {g}_{s} ⊆ \overline{G} )}{{P}_{Y} ( y \vert {g}_{s} ⊆ \overline{G} ) {P}_{\overline{G}} ( \overline{g} \vert {g}_{s} ⊆ \overline{G} )}$$

In authorship detection tasks, the token dependency can be regarded as the distinguishable motif. In practice, the good motifs have a significantly smaller number of edges. Similar to feature selection, what is considered significantly smaller can be determined by sparse learning with one parameter to control for sparsity.

To identify meaningful explanation patterns, in block 150, the GNN explainer y can rely on the Information Bottleneck principle, which states that optimal representations should maintain a balance between minimizing information while keeping it sufficient for accurate predictions. In other words, the GNN explainer y balances the size of the optimal explanation subgraph with the relevancy of the optimal explanation subgraph. Formally, the object of the Graph Information Bottleneck (GIB) principle for explanation extraction is concluded as follows:

G*=argGₛminI(G; Gₛ)−αI(Y; Gₛ) EQ. 7, where G*is the explanation subgraphs, α is a balance parameter. The first term minimizes mutual information between G and Gₛ, while the second term ensures Gₛ remains relevant to the label. Due to the computation intractability, to handle the problem, an approximation lower bound is used:

I(Y; Gₛ)≥ [symbol] [log P_{f}(Y|Gₛ)]+H(Y) EQ. 8. [symbol] stands for expectation. Gumber-softmax is on top of scholastic sampling.

Due to the H (Y) is a constant value, maximizing the [symbol] [log P_{f}(Y|Gₛ)] is used to optimize the second term of the previous equation. A higher lower bound means the subgraphs Gₛ are more predictive of the labels.

For the first item of G*=argGₛ minI(G; Gₛ)−αI(Y; Gₛ), there is an assumption that each edge in Gₛ has an independent probability of other edges. In the generated dependency graph, each edge represents the co-occurrence probability of the two tokens in all documents, aligned with the independent assumption. A variational approximation distribution R(Gₛ) is incorporated to approximate the distribution P(Gₛ). Then the upper bound is obtained as follows:

$$I ( G ; {G}_{s} ) \leq {\text{?}}_{G} [ KL ( {P}_{Ψ} ( {G}_{s} \vert G ) ‖ R ( {G}_{s} ) ] . \qquad EQ . 9$$

Specifically, there is an assumption the edge of i, j-th nodes from Gₛ is dependent on a Bernoulli variable

$${α}_{ij} \sim Bern ( {π}_{ij}^{′} ) .$$

The conditional probability P(Gₛ|G)=Π(vᵢ,vⱼ)εε P(αᵢⱼ|πᵢⱼ) always holds for any R(Gₛ). vᵢ and vⱼ denote the two nodes in the graph. ε denotes the set of all edges in the graph. Similarly, there is an assumption the edge of i, j-th nodes in Gₛ is a Bernoulli variable α′ᵢⱼ~Bern(r) where r is a predefined hyperparameter, then there is

$$R ( {G}_{s} ) = P ( n ) {\prod }_{( {v}_{i} , {v}_{j} ) ϵε}^{n} P ( {α}_{ij}^{′} ) .$$

The KL divergence can be converted into as follows:

$$EQ . 10$$

$$KL ( {P}_{Ψ} ( {G}_{s} \vert G ) ‖ R ( {G}_{s} ) = {\sum }_{( {v}_{i} , {v}_{j} ) ϵε} {π}_{ij} log \frac{{π}_{ij}}{r} + ( 1 - {π}_{ij} ) log \frac{1 - {π}_{ij}}{1 - r} + c ( n , r ) ,$$

where c(n, r) is a constant value. From EQ. 8 and 10, one can optimize the GIB object function the EQ. 7 by reducing the upper bound.

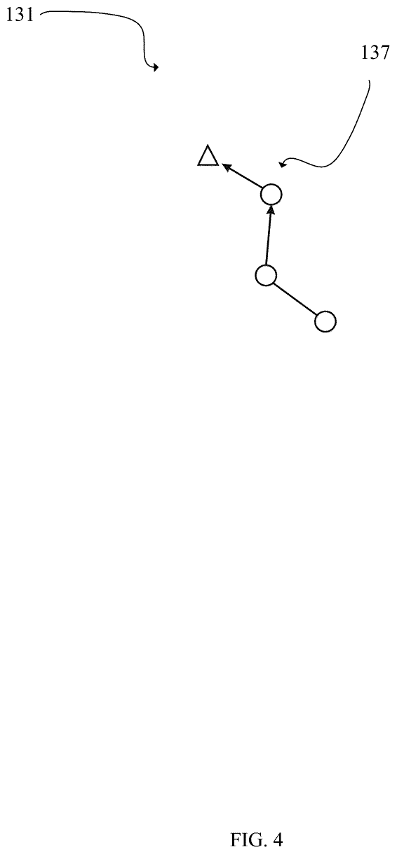

Referring to FIG. 4, the optimal explanation subgraph 137 of graph 131 that distinguishes the machine-generated texts from human-generated texts is obtained. The optimal explanation subgraph 137 can represent the motif. In this case, the motif represents the human-generated texts.

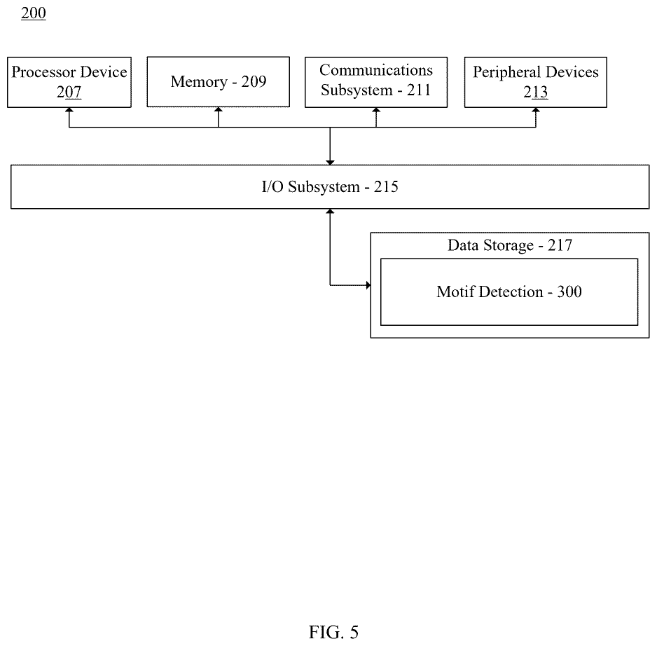

Referring now to FIG. 5, a block diagram of a computer system for motif detection, in accordance with an embodiment of the present invention.

The computing device 200 illustratively includes the processor device 207, the input/output (I/O) subsystem 215, the memory 209, the data storage device 217, and the communications subsystem 211, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 209, or portions thereof, may be incorporated in the processor device 207 in some embodiments.

The processor device 207 may be embodied as any type of processor capable of performing the functions described herein. The processor device 207 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 209 may be embodied as any type of volatile or non-volatile memory or data storage capable of performing the functions described herein. In operation, the memory 209 may store various data and software employed during operation of the computing device 200, such as operating systems, applications, programs, libraries, and drivers. The memory 209 is communicatively coupled to the processor device 207 via the I/O subsystem 215, which may be embodied as circuitry and/or components to facilitate input/output operations with the processor device 207, the memory 209, and other components of the computing device 200. For example, the I/O subsystem 215 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 215 may form a portion of a system-on-a-chip (SOC) and be incorporated, along with the processor device 207, the memory 209, and other components of the computing device 200, on a single integrated circuit chip.

The data storage device 217 may be embodied as any type of device or devices configured for short-term or long-term storage of data such as, for example, memory devices and circuits, memory cards, hard disk drives, solid state drives, or other data storage devices. The data storage device 217 can store program code for motif detection 300. Any or all of these program code blocks may be included in a given computing system.

The communications subsystem 211 of the computing device 200 may be embodied as any network interface controller or other communication circuit, device, or collection thereof, capable of enabling communications between the computing device 200 and other remote devices over a network. The communications subsystem 211 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 213. The peripheral devices 213 may include any number of additional input/output devices, interface devices, and/or other peripheral devices. For example, in some embodiments, the peripheral devices 213 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

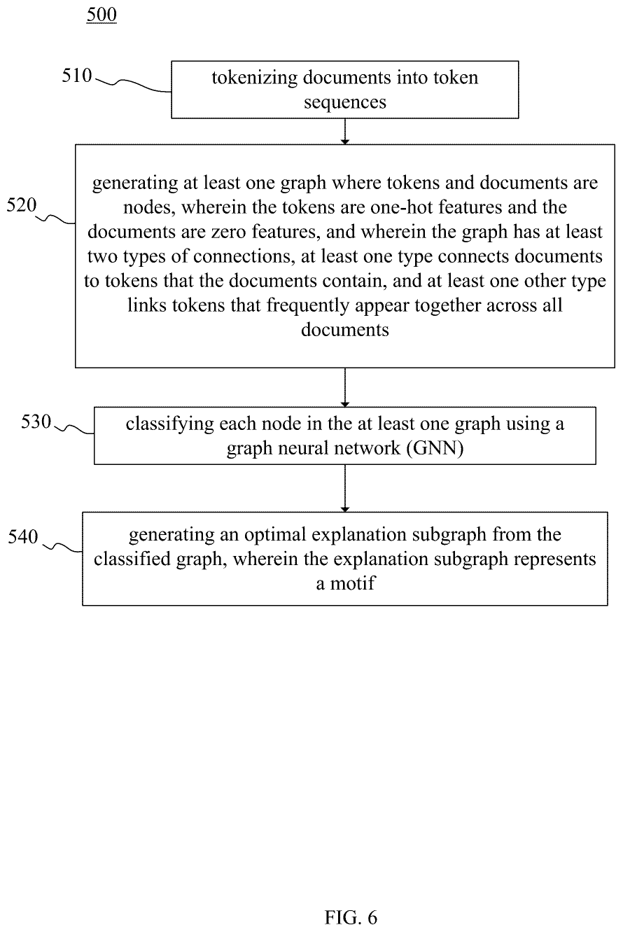

Referring now to FIG. 6, a flow diagram 500 of a high-level overview of motif detection, in accordance with an embodiment of the present invention.

In block 510, the documents are token into token sequences. This can be accomplished by a tokenizer.

In block 520, at least one graph is generated. The graph can have documents and tokens as nodes. The tokens can be one-hot features and the documents can be zero features. The graph can have at least two types of connections. At least one type of connection connects documents to tokens that the documents contain. This connection can be further defined as the term frequency-inverse document frequency (TF-IDF) of the word in the document. At least one other type links tokens that appear frequently appear together across all documents. This connection can be further defined as point-wise mutual information (PMI).

In block 530, each node is classified in the at least one graph using a graph neural network. This block can determine whether the text is human-generated or machine-generated. The graph neural network can be a graph convolutional network (GCN). The GCN can be a 3-layer GCN. The input dimension of a first layer of the GCN can be dependent on the token size of a training set. A second layer of the GCN can have a hidden dimension of 64, and an output layer of the GCN has a dimensionality that is fixed to the number of text categories.

In block 540, an optimal explanation subgraph is generated from the classified graph. The optimal explanation subgraph can represent a motif. The optimal explanation subgraph can be obtained by balancing the size of the optimal explanation subgraph with the relevancy of the optimal explanation subgraph.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for detecting machine-generated text, the method comprising:
tokenizing documents into token sequences;
generating at least one graph where tokens and documents are nodes, wherein the tokens are one-hot features and the documents are zero features, and wherein the graph has at least two types of connections, at least one type connects documents to tokens that the documents contain, and at least one other type links tokens that frequently appear together across all documents;
classifying each node in the at least one graph using a graph neural network (GNN); and
generating an optimal explanation subgraph from the classified graph, wherein the explanation subgraph represents a motif.

2. The method of claim 1, wherein generating an optimal explanation subgraph comprises:
balancing a size of the optimal explanation subgraph with a relevancy of the optimal explanation subgraph.

3. The method of claim 1, wherein the motif is a sentence structure that distinguishes machine-generated text from human-generated text.

4. The method of claim 1, wherein the motif represents word choices that distinguishes machine-generated text from human-generated text.

5. The method of claim 4, wherein an input dimension of a first layer of the GNN can be dependent on a token size of a training set, a second layer of the GNN can have a hidden dimension of 64, and an output layer of the GNN has a dimensionality that is fixed to a number of text categories.

6. The method of claim 1, wherein classifying each node in the at least one graph using a GNN further includes using a loss function defined as an aggregate cross-entropy error, over a set of labeled documents.

7. The method of claim 1, wherein at least one type of connection is a frequency-inverse document frequency (TF-IDF) of a word in the document.

8. The method of claim 1, wherein the at least one other type of connection uses point-wise mutual information to represent an edge attribution among tokens.

9. The method of claim 1, wherein the motif is used to support artificial intelligence (AI) agent decision-making.

10. A system, comprising:
a memory device; and
one or more processor devices operatively coupled with the memory device to perform operations, the operations including:
tokenize documents into token sequences;
generate at least one graph where tokens and documents are nodes, wherein the tokens are one-hot features and the documents are zero features, and wherein the graph has at least two types of connections, at least one type connects documents to tokens that the documents contain, and at least one other type links tokens that frequently appear together across all documents;
classify each node in the at least one graph using a graph neural network (GNN); and
generate an optimal explanation subgraph from the classified graph, wherein the explanation subgraph represents a motif.

11. The system of claim 10, wherein operations to generate an optimal explanation subgraph comprises:
balance a size of the optimal explanation subgraph with a relevancy of the optimal explanation subgraph.

12. The system of claim 10, wherein the motif is a sentence structure that distinguishes machine-generated text from human-generated text.

13. The system of claim 10, wherein the motif represents word choices that distinguishes machine-generated text from human-generated text.

14. The system of claim 10, wherein classifying each node in the at least one graph using a GNN further includes using a loss function defined as an aggregate cross-entropy error, over a set of labeled documents.

15. The system of claim 10, wherein at least one type of connection is a frequency-inverse document frequency (TF-IDF) of a word in the document.

16. The system of claim 10, wherein the at least one other type of connection uses point-wise mutual information to represent an edge attribution among tokens.

17. The system of claim 10, wherein the motif is used to support artificial intelligence (AI) agent decision-making.

18. A non-transitory computer program product comprising a computer-readable storage medium including a program code, wherein the program code when executed on a computer causes the computer to perform:
tokenize documents into token sequences;
generate at least one graph where tokens and documents are nodes, wherein the tokens are one-hot features and the documents are zero features, and wherein the graph has at least two types of connections, at least one type connects documents to tokens that the documents contain, and at least one other type links tokens that frequently appear together across all documents;
classify each node in the at least one graph using a graph neural network (GNN); and
generate an optimal explanation subgraph from the classified graph, wherein the explanation subgraph represents a motif, wherein generate an optimal explanation subgraph further comprises:
balance a size of the optimal explanation subgraph with a relevancy of the optimal explanation subgraph.

19. The computer program product of claim 18, wherein the motif is a sentence structure that distinguishes machine-generated text from human-generated text.

20. The computer program product of claim 18, wherein the motif represents word choices that distinguishes machine-generated text from human-generated text.
